(19) United States
(12) Patent Application Publication
(10) Pub. No.: US 2024/0171414 A1
(43) Pub. Date: May 23, 2024

(54) BLOCKCHAIN-BASED ELECTRONIC DOCUMENT VAULT

(71) Applicant: Block Vault, LLC, Spokane, WA (US)

(72) Inventors: Sean Edward Johnson, Spokane, WA (US); Todd M. Wesche, Salt Lake City, UT (US)

(21) Appl. No.: 18/518,172

(22) Filed: Nov. 22, 2023

Related U.S. Application Data
(60) Provisional application No. 63/427,472, filed on Nov. 23, 2022.

(51) Int. Cl. H04L 9/00; G06F 16/182

(52) U.S. Cl. CPC H04L 9/50; G06F 16/182

(57) ABSTRACT

A system and method for implementing and executing a blockchain-based electronic document vault for electronic document storage, access and management. As such, users may define, submit, deploy, and execute their electronic document storage, access and management in a fully transparent and secure fashion. Validating the electronic document and generating a document hash leads to the minting and tokenizing using an NFT of the encrypted electronic document in combination with an associated document hash providing for the formation of a digital document vault which is one of a plurality of digital document vaults of an electronic storage vault residing on a private blockchain. These individual digital document vaults of the electronic storage vault provides for the security of the electronic document (e.g., prevent unauthorized modifications) and controls access to only authorized individual(s) after their authentication.

### FIELD OF THE DISCLOSURE

The present disclosure relates generally to document management, and more particularly, to blockchain-based electronic document storage, access and management.

### BACKGROUND OF THE DISCLOSURE

The digital age has brought advances in many areas including the availability and ready access to information of all types. Digital records and documents have in many cases replaced the use and storage of paper hard copies. Modern document management systems employ computers and storage devices to store and track electronic documents, images of paper, and other types of digital content. Typical functions of electronic document management (EDM) involve the creation, storage, organization, transmission, retrieval, manipulation, update, and eventual disposition of documents to fulfill a specific purpose. A successfully implemented EDM may improve communication among different individuals and/or groups and improve their working efficiency. Many aspects of document management rely on document metadata which are descriptive or informational data concerning various aspects of underlying documents. With respect to each document, a corresponding set of metadata usually provides information about the document itself, its change or versioning history, related users, storage location, access or distribution restrictions, and any other information that might facilitate the understanding, use, or management of the document.

One of the most common uses of document metadata is to facilitate document retrieval. A single document may be directly retrieved from a document management system if a user provides a unique identifier of the document such as a document number. A list of documents may be retrieved by running a structured query language (SQL) search, which typically identifies relevant documents whose metadata match the specified search criteria. While a typical document management system can automatically generate some metadata for a document (e.g., detect its application type and assign a document number), a significant portion of the metadata is created by a human user who creates the document and/or other users who have entitlement to access the document. For example, when creating a new document, a user (e.g., author) may be prompted to enter information regarding the document, thereby establishing an initial set of metadata for that document. Other users who are authorized to make changes to that document may subsequently update it or create newer version(s) thereof, thereby changing the metadata of that document.

Unfortunately, electronic documents and computer readable files are susceptible to fraud and unauthorized modifications. Electronic documents and computer files can be generated and/or modified by unauthorized and/or unidentified users via many commercially available software programs and/or custom software “hacking” tools available via the Internet and other sources. Various solutions have been devised to reduce the likelihood of such information security breaches. For example, techniques focusing on encrypting the document or file and/or embedding a digital signature or certificate in the document or file. Existing techniques, individually and/or in combination, have failed to provide for the management of the complete document lifecycle (i.e., from creation through delivery) of secure electronic documents and/or computer files and to ensure their integrity is maintained.

### SUMMARY OF THE DISCLOSURE

The present disclosure is directed to a system and method that improves upon electronic document management techniques for the exchange of electronic documents of various types in a seamless, transparent, and secure fashion

The present disclosure is directed to a system and method that facilitates a blockchain-based electronic document vault for electronic document storage, access and management.

In a first implementation of the disclosure, a method is provided for facilitating a blockchain-based electronic document vault for electronic document storage, access and management. The method comprising: (i) receiving an electronic document; (ii) validating the electronic document received; (iii) generating a document hash of the validated electronic document; (iv) generating a private key for the validated electronic document; storing the private key generated in a central key repository; (v) encrypting the validated electronic document using the private key generated; (vi) minting a non-fungible token (NFT) for tokenizing the validated electronic document encrypted and the document hash generated; and (vii) forming, by recording the NFT minted as a particular one block of a plurality of blocks on a private blockchain, a particular one digital document vault of a plurality of digital document vaults of an electronic storage vault residing on the private blockchain, wherein the particular one digital document vault provides for storing the validated electronic document encrypted on the private blockchain and, controlling access to and use of the particular one digital document vault is managed as a function of at least the private key generated.

In a second aspect, a system is provided for implementing a blockchain-based electronic document vault for electronic document storage, access and management. The system comprising: a processor, and a memory storing instructions that when executed cause the processor to perform operations comprising: (i) receiving an electronic document; (ii) validating the electronic document received; (iii) generating a document hash of the validated electronic document; (iv) generating a private key for the validated electronic document; storing the private key generated in a central key repository; (v) encrypting the validated electronic document using the private key generated; (vi) minting a non-fungible token (NFT) for tokenizing the validated electronic document encrypted and the document hash generated; and (vii) forming, by recording the NFT minted as a particular one block of a plurality of blocks on a private blockchain, a particular one digital document vault of a plurality of digital document vaults of an electronic storage vault residing on the private blockchain, wherein the particular one digital document vault provides for storing the validated electronic document encrypted on the private blockchain and, controlling access to and use of the particular one digital document vault is managed as a function of at least the private key generated.

In a third aspect, a user device is for implementing a blockchain-based electronic document vault for electronic document storage, access and management. The user device comprising at least: a processor, and a memory storing instructions that when executed cause the processor to perform operations comprising: (i) receiving an electronic document; (ii) validating the electronic document received; (iii) generating a document hash of the validated electronic document; (iv) generating a private key for the validated electronic document; storing the private key generated in a central key repository; (v) encrypting the validated electronic document using the private key generated; (vi) minting a non-fungible token (NFT) for tokenizing the validated electronic document encrypted and the document hash generated; and (vii) forming, by recording the NFT minted as a particular one block of a plurality of blocks on a private blockchain, a particular one digital document vault of a plurality of digital document vaults of an electronic storage vault residing on the private blockchain, wherein the particular one digital document vault provides for storing the validated electronic document encrypted on the private blockchain, and controlling access to and use of the particular one digital document vault is managed as a function of at least the private key generated.

In a fourth aspect, a Block Vault document management application (alternatively referred to herein as an “app”) is provided for implementing and executing a blockchain-based electronic document vault for electronic document storage, access and management comprising the operations of at least: (i) receiving an electronic document; (ii) validating the electronic document received; (iii) generating a document hash of the validated electronic document; (iv) generating a private key for the validated electronic document; storing the private key generated in a central key repository; (v) encrypting the validated electronic document using the private key generated; (vi) minting a non-fungible token (NFT) for tokenizing the validated electronic document encrypted and the document hash generated; and (vii) forming, by recording the NFT minted as a particular one block of a plurality of blocks on a private blockchain, a particular one digital document vault of a plurality of digital document vaults of an electronic storage vault residing on the private blockchain, wherein the particular one digital document vault provides for storing the validated electronic document encrypted on the private blockchain and, controlling access to and use of the particular one digital document vault is managed as a function of at least the private key generated.

In a further aspect, the electronic document received is configured using a portable document format (PDF).

In a further aspect, the validating the electronic document received is performed in accordance with at least one International Organization for Standardization (ISO) promulgated standard.

In a further aspect, there is receiving, from a user, an access request associated with the electronic document received; authenticating the user and validating their access to the electronic document received; responsive to the authentication of the user and the validation of their access to the electronic document received, retrieving the private key stored from the central key repository; using the private key retrieved for accessing the particular one digital document vault of the plurality of digital document vaults of the electronic storage vault residing on the private blockchain thereby providing the user access to and use of the validated electronic document encrypted.

In a further aspect, there is accessing using the private key retrieved the particular one digital document vault of the plurality of digital document vaults of the electronic storage vault residing on the private blockchain and the minted NFT recorded for providing the user with access to and use of the validated electronic document encrypted thereof.

In a further aspect, the private key may be used to access an associated document vault of the plurality of digital document vaults of the electronic storage vault.

In a further aspect, a listing of electronic document for which a user is authorized to access is compiled and presented to the user.

In a further aspect, there is copying the validated electronic document encrypted into a secure cache; and decrypting, from the secure cache, the validated electronic document encrypted for accessing by the user.

In a further aspect, there is downloading the validated electronic document decrypted.

In a further aspect, there is displaying the downloaded validated electronic document decrypted to the user.

In a further aspect, there is removing the validated electronic document encrypted from the secure cache after the displaying the downloaded validated electronic document decrypted to the user.

In a further aspect, the storing the private key generated in a central key repository is by a third-party unaffiliated with the user, and any author of, party to, or individual identified in the electronic document received.

In a further aspect, there is applying a digital signature of an individual to the electronic document received, wherein the individual is an author of, a party to, or identified in the electronic document received.

In a further aspect, there is applying a digital signature of the unaffiliated third-party to the electronic document received.

In a further aspect, the storing the private key generated in a central key repository is configured using a private key server or private key store.

In a further aspect, the private key generated is stored in a digital wallet.

In a further aspect, the electronic document received is an estate planning document.

In a further aspect, the private key generated is one of a plurality of private keys controlled solely by the unaffiliated third-party.

In a further aspect, there is storing the electronic document received in a database.

In a further aspect, there is storing information identifying the location of the electronic document stored in the associated digital document vault within the private blockchain.

In a further aspect, a third-party unaffiliated with any author of, party to, or individual identified in the electronic document received is administering the electronic storage vault residing on the private blockchain.

These and other characteristics, features, and advantages of the present disclosure will become more readily apparent from the attached drawings and the detailed description of the example embodiments, which follow.

### BRIEF DESCRIPTION OF THE DRAWINGS

The example embodiments of the disclosure will hereinafter be described in conjunction with the appended drawings provided to illustrate and not to limit the disclosure, where like designations denote like elements, and in which:

FIG. 1 presents a high-level block diagram of a network architecture for providing a blockchain-based electronic document vault for electronic document storage, access and management in accordance with an embodiment;

FIG. 2 presents a high-level diagram schematically depicting storing an electronic document using a blockchain-based electronic document vault in accordance with an embodiment;

FIG. 3 presents a high-level diagram schematically depicting electronic document access and management using a blockchain-based electronic document vault in accordance with an embodiment;

FIG. 4 presents a flowchart of illustrative operations for implementing a blockchain-based electronic document vault for storing an electronic document in accordance with an embodiment;

FIG. 5 presents a flowchart of illustrative operations for electronic document access and management using a blockchain-based electronic document vault in accordance with an embodiment;

FIG. 6 presents a Block Vault document management system configured in accordance with an embodiment;

FIG. 7 presents a user device configured in accordance with an embodiment; and

FIG. 8 presents an illustrative architecture for a Block Vault document management app for implementing a blockchain-based electronic document vault for electronic document storage, access and management in accordance with an embodiment.

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present disclosure is directed toward a system and method for implementing and executing a blockchain-based electronic document vault for electronic document storage, access and management. As such, users (e.g., lawyers, estate planning professionals, court docket administrators, insurance adjusters, product warranty and service administrators, healthcare professionals and personal records administrators) may define, submit, deploy, and execute their electronic document storage, access and management in a fully transparent and secure fashion. Validating the electronic document and generating a document hash leads to the minting and tokenizing using an NFT of the encrypted electronic document in combination with the associated document hash providing for the formation of a digital document vault which is one of a plurality of digital document vaults of an electronic storage vault residing on a private blockchain. This digital document vault supported by the blockchain-based electronic storage vault provides for the security of the electronic document (e.g., prevent unauthorized modifications) and controls access to only authorized individual(s). That is, a particular one digital document vault provides for storing the validated electronic document encrypted using an NFT on the private blockchain whereby a controlled access to and use of the particular one digital document vault is managed as a function of at least the private key generated. Thus, access to and use of the electronic document is by and through the associated digital document vault. Illustratively, such controlled access to and use of the digital document vault is administered by an unaffiliated third-party that issues and controls the private keys (each one private key associated with a particular one digital document vault) which are utilized by the system (or in accordance with the method) for executing controlled access to and use of the particular one digital document vault as a function of the private key generated. As such, any one authorized user is never provided the private key itself for any purpose but rather once authenticated they are provided access to the desired electronic document by and through the associated digital document vault on the private blockchain (and the associated NFT used for tokenizing the encrypted and validated electronic document together with a generated document hash therefrom) as a function of the unaffiliated third-party managed and controlled private key. Importantly, the blockchain-based electronic document vault system and method of the disclosed embodiments provides an advantageous improvement of practical applications including, but not limited to, electronic document storage and management systems, blockchain-based transactions systems and the hardware and software infrastructure supporting the aforementioned systems. This solves a transparency problem and increases the security of electronic document processing and provides for the definition and execution of electronic document storage, access and management using blockchains and tokenized electronic documents using NFTs. This decreases the potential for fraud, increases security and increases overall electronic document disposition processing efficiency. In accordance with the disclosed embodiments, there can be no doubt what individual made, executed and/or is a party to a particular electronic document and whether that electronic document is up-to-date and what other persons have may access the electronic document due to the nature of the blockchain-based electronic document vault system and method and the security features provided thereby.

To provide further context for the subject disclosure, a high-level discussion of distributed ledger technology (DLT), blockchains, and smart contracts will now be discussed. Blockchain is a distributed database that records all transactions that have ever occurred in a network, for example. Blockchain was originally introduced for Bitcoin (a peer-to-peer digital payment system), but then evolved to be used for developing a wide range of decentralized applications. A blockchain is a distributed digital ledger which is communicated electronically between hardware devices. Each transaction recorded within the digital ledger is a block which can be hashed or otherwise encrypted. As new transactions are added to the digital ledger, each transaction's veracity can be tested against the previous ledger stored by the devices. In some configurations, there may be a requirement that some fixed percentage (e.g., fifty percent (50%)) of the user devices must confirm the transaction's veracity before being added to the blockchain. As such, a blockchain is a distributed database that records all transactions that have ever occurred in the blockchain network. This database is replicated and shared among the network's participants (or a subset thereof in some implementations). The main feature of blockchain is that it allows untrusted participants to communicate and send transactions between each other in a secure way without the need of a trusted third party. In this way, blockchain is an ordered list of blocks, where each block is identified by its cryptographic hash. Each block references the block that came before it, resulting in a chain of blocks. Each block consists of a set of transactions. Once a block is created and appended to the blockchain, the transactions in that block cannot be changed or reverted. This is to ensure the integrity of the transactions, for example, the smart contract execution that may be governing the electronic document storage, access, and management and employing the blockchain-based electronic document vault in accordance with the principles of the embodiments herein.

In essence, as noted previously, a blockchain is a transaction ledger that maintains identical copies across each computer of a member network and the fact that the ledger is distributed across part of the network facilitates the security of blockchain. A blockchain relies on three important components: private key technology, a distributed network that includes a shared ledger, and an accounting means for the transactions and records across the network. A blockchain is a list of records that are cryptographically linked together such that each block of the blockchain contains a cryptographic hash of the previous block, a timestamp, and transaction data. Thus, a blockchain is highly resistant to date modification due to the design feature that once recorded the data in any given block cannot be altered without alteration of all subsequent blocks. In many applications, the constructed distributed ledger is managed within a peer-to-peer network that allows participants to verify and audit transactions in an efficient manner. By combining the use of cryptographic keys with a distributed network, blockchain expands the type and number of digital transaction possibilities.

One appealing application that can be deployed on top of blockchain are so-called smart contracts. A smart contract is executable code that runs on the blockchain to facilitate, execute, and enforce the terms of an agreement between parties (e.g., the storage, access and management of electronic documents hereunder). It can be thought of as a system that releases digital assets to all or some of the involved parties once the pre-defined rules have been met. The main aim of a smart contract is to automatically execute the terms of an agreement once the specified conditions are met. Before a smart contract may process transactions, the smart contract must be deployed on the blockchain. The deployment process must guarantee that all blockchain nodes have exactly the same program code. Generally, blockchain designs employ two smart contract deployment approaches. One approach is to save the smart contract code itself in the blockchain thereby guaranteeing global node consensus (so-called “on-chain”), and the other is to allow each node owner to decide if the node should have the code installed locally and use a hash-based commitment in the blockchain as reference for validating the integrity thereof (so-called “off-chain). Smart contracts are executed by the blockchain nodes, as a result of processing transactions that are submitted by the user. A blockchain transaction has a designated smart contract function and a payload that contains input values to the function call. A transaction may be submitted at any node in the blockchain network, which broadcasts the transaction to the entire network, so all of the nodes are aware of the transaction. At a particular point, the transaction is processed by each of the nodes using the executable program code in the target smart contract. If the transaction is successful, the internal state of the blockchain will be updated. If the trigger input is determined to be invalid and rejected by the smart contract, then the overall state is not affected. For example, the smart contract may be triggered by a specific event (“if A happens, then action B”). In this way, a smart contract functions as a trusted distributed application that gains security/trust from the blockchain and the underlying consensus among the peers. Smart contracts must be independently executed by a quorum of blockchain nodes. Unlike traditional database structures, blockchains are decentralized such that every node assumes other nodes are potentially malicious and a node never trusts states maintained by other nodes in the network. Instead, each node maintains their own state database by executing the transaction itself using the smart contract code. Thus, each smart contract maintains their own set of states and transactions submitted to a blockchain may target a smart contract. Once a transaction is executed, the target smart contract updates its state and one smart contract may call another smart contract in order to query, for example, the downstream smart contract's state or update the same. Only valid transactions result in updated states and invalid transactions are either rejected by the blockchain network from being included in the blockchain or included but marked as failed depending upon the particular blockchain design. In this way, the deployed smart contract serves as a form of execution logic for a blockchain application. Thus, smart contracts promise low transaction fees compared to traditional systems that require a trusted third party to enforce and execute the terms of an agreement. There are different blockchain platforms that can be utilized to develop and deploy smart contracts, and Ethereum is a common platform for developing smart contracts.

Ethereum is a public blockchain platform that can support advanced and customized smart contracts with the help of Turing-complete programming language. Ethereum is a decentralized blockchain platform that establishes a peer-to-peer network that securely executes and verifies application code (e.g., smart contracts). Ethereum is a platform powered by blockchain technology that may be best known for its native cryptocurrency, called ether (or ETH), or simply Ethereum. In this way, a user/sender must sign transactions and spend ETH as a cost of processing transactions on the network. Smart contracts, as previously noted, allow participants to transact with each other without a trusted central authority. Transaction records are immutable, verifiable, and securely distributed across the network, giving participants full ownership and visibility into transaction data. Transactions are sent from and received by user created Ethereum accounts. Ethereum offers an extremely flexible platform on which to build decentralized applications using the native Solidity scripting language and Ethereum Virtual Machine (EVM). The code of Ethereum smart contracts is written in a stack-based bytecode language and executed in the EVM. Several high-level languages (e.g., Solidity and Serpent) can be used to write Ethereum smart contracts. The code of those languages can then be compiled into EVM bytecodes to be executed. Decentralized application developers who deploy smart contracts on Ethereum benefit from the rich ecosystem of developer tooling and established best practices that have come with the maturity of the protocol. This maturity also extends into the quality of user-experience for the average user of Ethereum applications, with digital/cryptocurrency wallets such as MetaMask, Argent, Rainbow, and more offering simple interfaces through which to interact with the Ethereum blockchain and smart contracts deployed thereon. Ethereum's large user base encourages developers to deploy their applications on the network, which further reinforces Ethereum as the primary platform for decentralized applications like decentralized finance (DeFi), decentralized applications (dApps), and non-fungible tokens (NFTs). The distributed nature of blockchain technology is what makes the Ethereum platform secure, and that security enables ETH to accrue value.

Another blockchain platform that is increasingly gaining traction is the Hyperledger Fabric (also referred to as “Fabric”) as established by the Linux Foundation (see, e.g., LFS272: Hyperledger Fabric Administration, version 8.24, dated May 26, 2021) with a major focus on enterprise uses that require participants to be identified/identifiable, permissioned networks, high transaction throughput performance, low latency of transaction confirmation and privacy and confidentiality of transactions and data pertaining to business transactions. Fabric is the first distributed ledger platform to support smart contracts authored in general-purpose programming languages such as Java, rather than domain-specific languages (DSL). As such, enterprises can more easily develop smart contracts without the need to learn a specific/new programming language. The Fabric platform is also permissioned in that, unlike a public permissionless network, the participants are known to each other, rather than anonymous and therefore fully untrusted. This means that while the participants may not fully trust one another (e.g., if they are adverse parties or competitors) a network can be operated under a governance model that is constructed as a function of whatever trust does exist between participants, such as a legal framework. These features make Fabric one of the better performing platforms that are currently available both in terms of transaction processing and transaction confirmation latency. Further, this platform enables privacy and confidentiality of transactions and smart contracts that implement them.

Fabric has been specifically designed with a modular architecture making it very adaptable and customizable for various use cases. The modular components include (i) a pluggable ordering service that established consensus on the order of transactions and then broadcasts blocks to peers; (ii) a pluggable membership service provider that is responsible for associating entities in a network with cryptographic identities; (iii) smart contracts (so-called chain code) run within a contained environment for isolation and can be written in standard programming languages; (iv) the ledger can be configured to support a variety of database management systems (DBMS); and (v) a pluggable endorsement and validation policy enforcement can be independently configured per application.

Further, encrypted data in the form of NFTs may be employed across a blockchain. As will be appreciated, an NFT is a unit of data stored on a digital ledger (as described above), that certifies a digital asset to be unique and therefore not interchangeable. NFTs are digital identifiers that can be used to represent items including, not limited to, documents, photos, videos, audio, property, and other types of digital files. Currently, NFTs are bought and sold online, frequently with cryptocurrency, and they are generally encoded with the same underlying software as many cryptocurrencies. Access to any copy of the original file, however, is not restricted to the owner of the NFT. While copies of these digital items are available for anyone to obtain, NFTs are tracked on a blockchain to provide the owner with a proof of ownership that is separate from a copyright, for example. That is, an NFT is a unit of data stored on the digital ledger (e.g., the blockchain), which can be sold, traded and/or transferred. The NFT can be associated with a particular digital or physical asset (such as a file or a physical object) and a license to use the asset for a specified purpose or for transferring the ownership of the asset from one owner to another. NFTs (and the associated license to use, copy or display the underlying asset or the ownership assignment thereof) can be traded and sold on digital markets. In this way, NFTs function like cryptographic tokens, but, unlike other tokens (e.g., Bitcoin), NFTs are not mutually interchangeable, hence not fungible. Thus, each NFT may represent a different underlying individual asset and thus have a different value. NFTs are created, for example, when blockchains string records of cryptographic hash a set of characters identifying a set of data onto previous records thereby creating a chain of identifiable data blocks. This cryptographic transaction process ensures the authentication of each digital file by providing a digital signature that is used to track NFT ownership. An NFT is a unique digital token, with most using, for example, the above-referenced Ethereum blockchain to digitally record transactions. Again, the NFT is not a cryptocurrency like Bitcoin or Ethereum, because those are fungible (i.e., exchangeable for another Bitcoin or cash). However, NFTs are recorded in the digital ledger in the same way as cryptocurrency, so there is a listing of who owns each one. In this way, blockchains act as a decentralized system for recording and documenting transactions that involve a specific NFT and/or a plurality of NFTs. In essence, as noted previously, a blockchain is a transaction ledger that maintains identical copies across each computer of a member network and the fact that the ledger is distributed across part of the network facilitates the security of blockchain. Importantly, in accordance with the principles of the disclosed embodiments, after validating the electronic document, generating a document hash thereof, generating a private key specific to the validated electronic document, and encrypting the validated electronic document there is the minting and tokenizing using an NFT of the encrypted electronic document in combination with the associated document hash providing for the formation of a digital document vault which is one of a plurality of digital document vaults of an electronic storage vault residing on a private blockchain. This digital document vault can thereafter be employed to control secure access to the encrypted electronic document by and through managing the distribution of the private key specific thereto. In an aspect of the disclosed embodiments, the private keys are generated and stored in a central key repository by a third-party unaffiliated with any of the author(s) and/or any of the parties relevant to the particular electronic document stored in the digital document vault. Of course, there are various mechanisms for such private key storage including, but not limited to, using a private key server, a private key store or a digital wallet that are consistent with the principles of the disclosed embodiments.

As will be appreciated, transacting smart contracts and NFTs carries an associated expense when using Ethereum. “Gas” refers to the computational effort required to execution operations on the blockchain, and any user must pay a gas fee in order to make transactions or executed smart contracts on Ethereum, for example. Further, gas is the term given to the fee that most NFT trading platforms charge. Thus, gas fees are incurred to conduct the transaction or execute a smart contract on their blockchain platform. For example, gas prices in Ethereum are denoted by a unit of gwei, which itself is a denomination of ether (ETH) that is the native cryptocurrency of the Ethereum platform. Each gwei is equal to 0.000000001 ETH. For example, instead of designating that the user's gas costs 0.000000001 ether, this translates to a cost of 1 gwei. The valuation is determined by the amount of traffic on the network and the computation power taken to execute a transaction. Gas fees are payments that users have to make to compensate for the computation energy required to process transactions on the Ethereum blockchain. Ethereum implements something called the proof of work algorithm. In this blockchain, validators who use special algorithms (called miners) solve cryptographic problems. Finding a successful solution to this problem enables sets of transactions to be processed and added to the blockchain. Everything on the Ethereum network costs some denomination of gas. Interestingly, one difference with respect to Hyperledger Fabric is that the Fabric platform does not currently have any native token or cryptocurrency in the system. So, a user currently does not need to have cryptocurrency in order to use this platform and there is no notion of gas. Gas on the Ethereum network is assigned a market price based upon the demand for resources in the network at a particular moment in time. Therefore, the valuation of Ethereum gas depends upon the supply and demand in the network. If there is high demand for transactions, this requires more miners to complete complicated algorithms creating more work and energy consumption; hence increasing the gas fee. If the gas price does not meet the threshold power, it cannot process the transactions. The user may decide the maximum gas amount they want to spend on a transaction and may set a limit on the gas price expended and wait until such price reaches that limit. This ensures that a user has some control over the transaction expenses. For example, if a user is willing to wait then the transaction will get processed when the gas limit set has been reached. The main criteria for gas expenses will depend upon the size of the smart contract for execution on the blockchain as well as the speed at which the user wants that transaction to be completed.

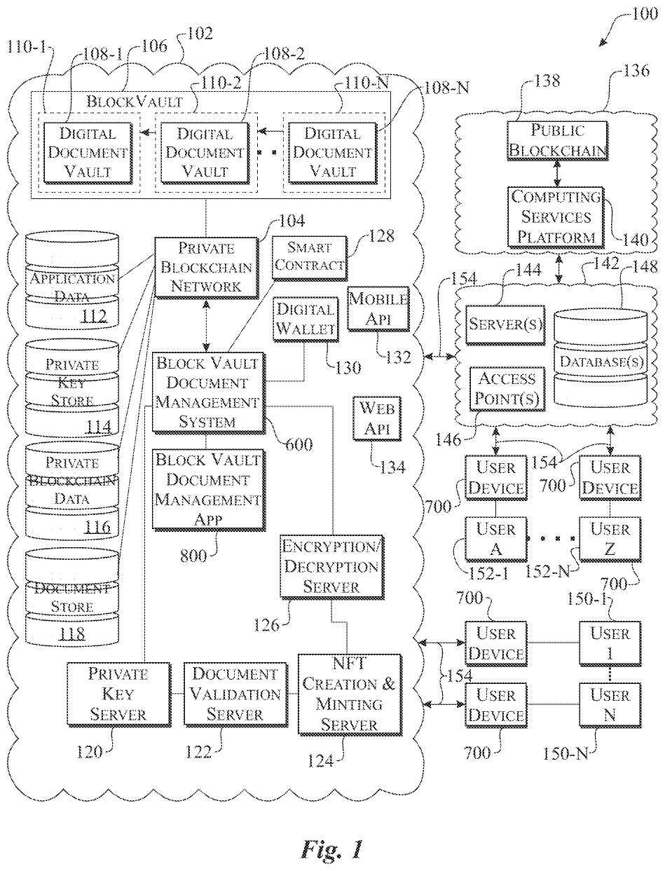

Turning our attention to FIG. 1, a high-level block diagram is presented of cloud network services architecture 100 comprising a plurality of platforms implemented in accordance with an embodiment of the disclosure. For example, a private cloud environment 102 for implementing a permissioned, e.g., private blockchain network 104 that is controlled by a single authority, and a public cloud environment 136 for executing a permissionless, e.g., public blockchain 138. In some implementations, the public blockchain 138 may be provided using a computing services platform 140 administered by Amazon Web Services (AWS), but other such computing services platforms may also be used (e.g., Microsoft Azure or Google Cloud). In this way, in accordance with the principles of the disclosed embodiments, the private cloud environment 102 and/or the public cloud environment 136 may be employed to deliver a blockchain-based electronic storage vault 106 (also referred to herein as Block Vault 106) comprising a plurality of digital document vaults (e.g., digital document vault 108-1, digital document vault 108-2 through digital document vaults 108-N) residing the private blockchain (e.g., block 110-1, block 110-2 through block 110-N). As will be appreciated, the cloud network services architecture 100 may comprise a plurality of servers, access points and databases in the operation and execution of the respective cloud environments. For avoidance of doubt, as used herein, a public blockchain broadly refers to a blockchain that has been implemented as a permissionless blockchain, meaning anyone can read or write to the blockchain. One advantage of such a public blockchain is it allows individuals who do not know each other to trust a shared record of events without the involvement of an intermediary or third party. Conversely, a private blockchain broadly refers to a permissioned blockchain where the blockchain's participants are known and are granted read and write permissions by an authority that governs the use of the private blockchain.

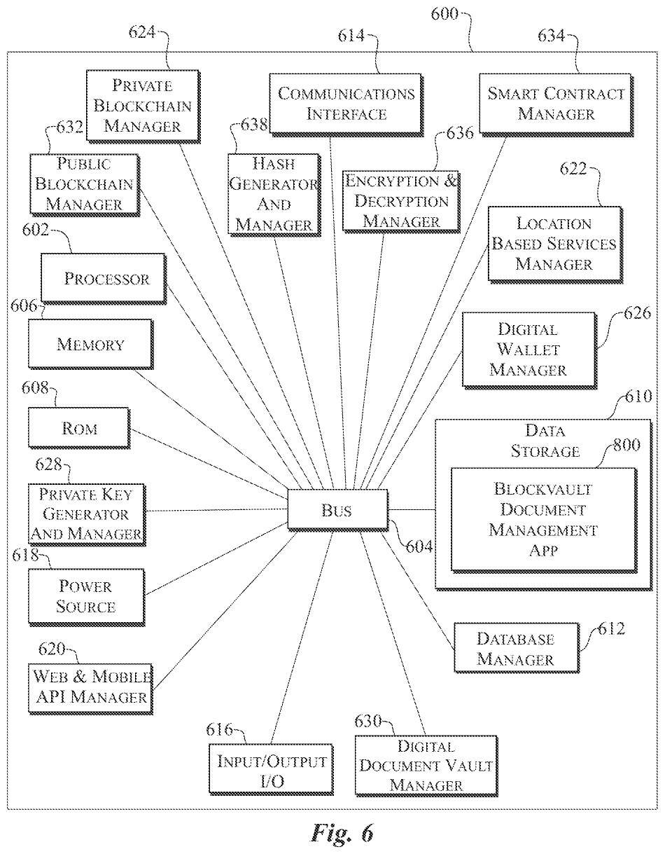

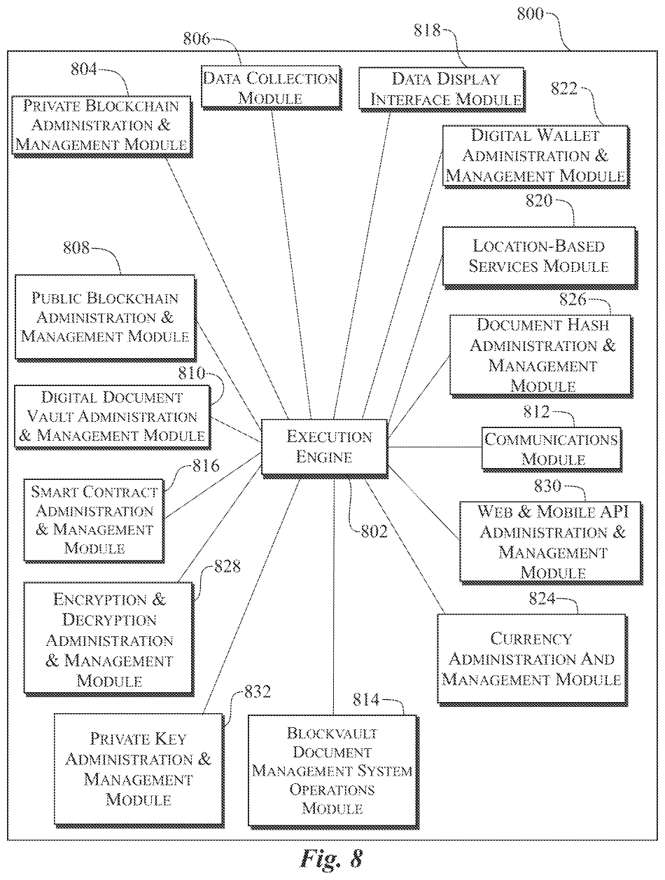

Illustratively, in addition to the private blockchain network 104, the private cloud environment 102 comprises Block Vault document management system 600 (as shown in FIG. 6 in an embodiment and discussed in greater detail herein below) that may employ one or more data and information repositories such as application data 112, private key store 114, private blockchain data 116, and document store 118 in the execution of Block Vault document management app 800 (see, FIG. 8). The Block Vault document management app 800 is an application that when executed will deliver the blockchain-based electronic storage vault as discussed in detail herein. As noted, the private blockchain network 104 in an embodiment is a private/permissioned blockchain(s) (which may also be referred to as a managed blockchain(s)) controlled by a single organization (in this case, for example, the provider and/or administrator of the Block Vault document management system 600 and/or the Block Vault document management app 800). In a private blockchain, the central authority determines who can be a node and the central authority also does not necessarily grant each node with equal rights to perform functions. As such, the private blockchain network 104 has several advantages, including the use of cryptographic approaches known to those of skill in the art for identity management and verification of transactions thereby providing protection against malicious activities intended to compromise a transaction by changing the transaction's details. Moreover, permission controls typically associated with private blockchains can provide dynamic control over who can connect, send, receive, and enact individual transactions, based upon any number of parameters that may not be available or implementable in public blockchains. Accordingly, full control can be asserted over every aspect of the operation of a blockchain, not only in accordance with the consensus of its various participants, but the blockchain's administrative intermediary as well.

In accordance with the principles of the disclosed embodiments, after validating the electronic document, generating a document hash thereof, generating a private key specific to the validated electronic (e.g., using document validation server 122) document, and encrypting the validated electronic document (e.g., using encryption/decryption server 126) there is the minting and tokenizing using an NFT (e.g., using NFT creation and minting server 124) of the encrypted electronic document in combination with the associated document hash providing for the formation of a digital document vault which is one of a plurality of digital document vaults of an electronic storage vault residing on a private blockchain. This digital document vault can thereafter be employed to control secure access to the encrypted electronic document by and through managing the distribution of the private key specific thereto. In an aspect of the disclosed embodiments, the private keys are generated and stored in a central key repository by a third-party unaffiliated with any of the author(s) and/or any of the parties relevant to the particular electronic document stored in the digital document vault. Advantageously, in accordance with the principles of the disclosed embodiments, the private keys that are generated (e.g., using private key server 120) and stored in a central key repository (e.g., the private key store 114) by a third-party unaffiliated with any of the author(s) and/or any of the parties relevant to the particular electronic document stored in the digital document vault (e.g., the Block Vault 106).

Private blockchains are only partially decentralized because public access to these blockchains is restricted. Some examples of known private blockchains are the business-to-business virtual currency exchange network Ripple, R3's Corda, and Hyperledger, an umbrella project of open-source blockchain applications (as noted herein above). These are permissioned systems which, in the case of Corda and Hyperledger, restrict access to transaction data to the parties involved in that transaction, rather than the data being made public in a public ledger like Bitcoin. Illustratively, the private blockchain network 104 may be a private blockchain architecture designed using Hybrid Fabric or Hyperledger Besu which is an open-source Ethereum client developed for enterprise applications requiring secure, high-performance transaction processing in a private network as well as Block Vault document management app 800 which is designed, in an embodiment, as a mobile-based app architecture the execution of which is facilitated by mobile application programming interface (APT) 132. As will be appreciated, Hyperledger Besu may be used to connect to a public network (e.g., the existing public Ethereum network) and may be configured to perform as a full node that synchronizes to the blockchain and an archive node, which contains the data of the blockchain but does not participate in adding new blocks. Besu can also be used to create a private blockchain network (e.g., the private blockchain network 104), compatible to the Ethereum Virtual Machine (EVM), for customized blockchain applications including, but not limited to, the Block Vault document management app 800.

As will be appreciated, a mesh network may be employed between various parties for various purposes hereunder. For example, an illustrative mesh network may employ a peer-to-peer configuration that includes six (6) nodes between a plurality of parties. In this example, node A is associated with the party 1, node B is associated with the party 2, node C is associated with party 3, node D is associated with party 4, node E is associated with party 5, and node F is associated with party 6. This illustrative mesh network is configured such that each node can communicate with and relay data to each of the other nodes. In this way, the various parties may use their respective user devices to communicate with each other across the mesh network in performing the various operations and/or actions required by the Block Vault document management system 600 and Block Vault document management app 800 processing. Of course, this illustrative configuration is only one of many different possibilities that may be utilized to deploy the smart contracts, for example, across the private blockchain in accordance with the principles of the disclosed embodiments.

As noted above, in the framework of the principles of the disclosed embodiments, a blockchain is a distributed ledger of all transactions that have been executed in a particular context (e.g., the blockchain-based electronic storage vault hereunder). The blockchain constantly enlarges as completed blocks are added thereto as new transactions are addressed. Typically, blocks are added to the blockchain in a linear, chronological order by the various user devices involved in the transaction(s) and are interconnected in executing the blockchain protocol, for example, in a peer-to-peer network. The peer-to-peer network is essentially a plurality of interconnected nodes (e.g., node A, node B, node C, node D, node E, and node F) with each node associated with a particular user device the employs a client to validated and relay transactions.

In this way, the blockchain is distributed among multiple devices associated with multiple parties. For example, party A, party B, party C, party D, and party E. In this example, a block 1 is added to the blockchain by party A and may contain the party TD of party A or an address/identification of the user device associated and used by the party A, and may also contain data (e.g., relevant smart contract transaction data). Also, the block 1 may contain an authentication portion that may be used to set restrictions of various levels on the data and/or the party TD. For example, the party TD and the data may be set such that they are not accessible to one or more of the other parties. This may be advantageous if party A, for example, does not want party D to have access to certain of the data. The data may be part of one of the smart contracts 128 employed by the Block Vault document management system 600 and associated operations in applying smart contract transactions processing hereunder. In turn, the smart contract is stored on the blockchain and executed automatically as part of the respective transactions executed. As the user device(s) generate additional blocks, each such block is hashed into the previous blockchain resulting in an updated blockchain which continues to be distributed among the various parties and their respective user devices. The blockchain protocol may include a so-called proof of work or proof of stake scheme that is based on a cryptographic hash function (CHF), for example, the secure hash algorithm 256 (SHA-256). This hash function may also be used to generate the electronic document hashes required for use with the blockchain-based electronic storage vault processing hereunder. Generally, the CHF receives information as input and provides a hash value output, wherein the hash value has a predetermined length. For example, SHA-256 provides a 256-bit (32-byte, 64 character) hash value output. The blockchain may also require multiple information pieces as input to the CHF. The input, for example, may include a reference to the previous (i.e., most recent) block in the blockchain, details of the transaction(s) that are to be included in the to-be-created block, and a nonce value (e.g., a random number used a single time). Further, the blockchain protocol provides a threshold hash to qualify a block to be added to the blockchain. For example, the threshold hash may include a predefined number of zeros (0's) that the hash value must have at the start, and the higher the number the more effort that is required to arrive at the qualifying hash. Accordingly, similar to party A, parties B, C, D and E may generate additional blocks, respectively, that are hashed into the blockchain which results in a further updated blockchain that is distributed to the respective use devices of the various engaged parties

Various embodiments contemplate the definition, administration and use of cryptocurrencies with the Block Vault document management system 600 and the Block Vault document management app 800. Such cryptocurrencies will be utilized for paying for the use of the Block Vault 106 administered by the Block Vault document management system 600 and the Block Vault document management app 800. In a further embodiment, a fiat currency (e.g., U.S. dollars) may be utilized for payments. As will be appreciated, digital currency is a currency form that is available in electronic or digital form, but not in physical form. Digital currencies exist and are only accessible with electronic devices, for example, computers and smartphones. That is, digital currencies are intangible and are owned and transacted by using computers or electronic wallets that have access to specifically designated computer networks. Digital currencies have all the intrinsic properties of physical currency (e.g., banknotes or minted coins) and allow for instantaneous transactions that are seamlessly executed for making payments across borders and geographic boundaries when the parties are interconnected to supported hardware devices and networks. Cryptocurrencies have emerged as the first generation of blockchain technology. Cryptocurrencies are basically digital currencies that are based on cryptographic techniques and peer-to-peer networks. Today, a number of digital currencies variants, regulated or unregulated, exist such as cryptocurrencies and virtual currencies. A cryptocurrency is another form of digital currency that uses cryptography to secure and verify transactions and to manage and control the creation of new currency units. Currently, cryptocurrencies are unregulated so they may also be considered so-called virtual currencies. That is, virtual currencies are an unregulated digital currency that is controlled by its developers, a founding organization, or a defined network protocol. To be clear, the principles of the disclosed embodiments apply equally to any type of digital currency including, but not limited to, a cryptocurrency, a virtual currency, a central bank digital currency (CBDC), and a digital currency electronic payment (DCEP). In an aspect, currently available public cryptocurrencies may be used including, but not limited to, Bitcoin (BTC), Ethereum (ETH), Binance Coin (BNB), Tether (USDT), Solana (SOL), XRP (XRP), Cardano (ADA), USD Coin (USDC), Binance USD (BUSD), and Avalanche (AVAX).

In various embodiments, the Block Vault document management system 600, the private blockchain network 104 and the Block Vault document management app 800 allow for the use of the various types of currencies including, but not limited to, fiat currencies and cryptocurrencies (as managed using currency administration and management module 824, see FIG. 8) pursuant to one or more smart contracts (e.g., smart contracts 128), for example, with each user assigned at least one digital wallet of a plurality of digital wallets 130. In an aspect, one or more of the digital wallets 130 is configured as an Ethereum wallet. In another aspect, one or more the digital wallets 130 may be accessed through the public blockchain 138. In this way, in an embodiment, there is the providing, by the Block Vault document management system 600 using the private blockchain network 104 and/or the public blockchain 138, a plurality of digital wallets, wherein each digital wallet of the plurality of wallets being specific to one of the plurality of users.

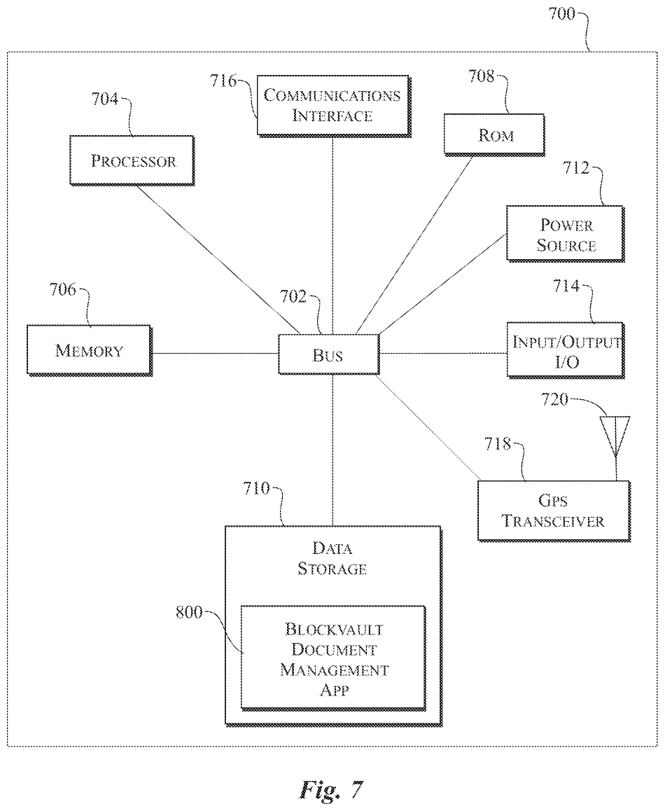

In the embodiment shown in FIG. 1, a plurality of users (i.e., user 1 150-1 through user N 150-N and user A 152-1 through user Z 152-N) engage with the Block Vault document management system 600, the private blockchain network 104, and the Block Vault document management app 800 deployed on the private cloud environment 102 and/or the public blockchain 138 deployed on the public cloud environment 136 using a respective user device of a plurality of user device 700 (see, FIG. 7), as further detailed herein below. Illustratively, this may be facilitated by communicating by and through cloud network 142 comprising at least server(s) 144, access point(s 146 and database(s) 148. Further, in an embodiment, the Block Vault document management app 800 is configured to execute as mobile applications managed by and through the mobile APT 132. Communications are facilitated across communications links 154 of the cloud network services architecture 100 in accordance with any number of well-known communications protocols and methods (e.g., wireless communications). This may take the form, for example, of a wide area network connection that communicatively couples the Block Vault document management system 600 and/or the user devices 700 with one or more access points which may be a cellular communications service. Similarly, communications managed may take the form, for example, of a local Wi-Fi network interface or Ethernet interface for communicatively coupling with the well-known Internet.

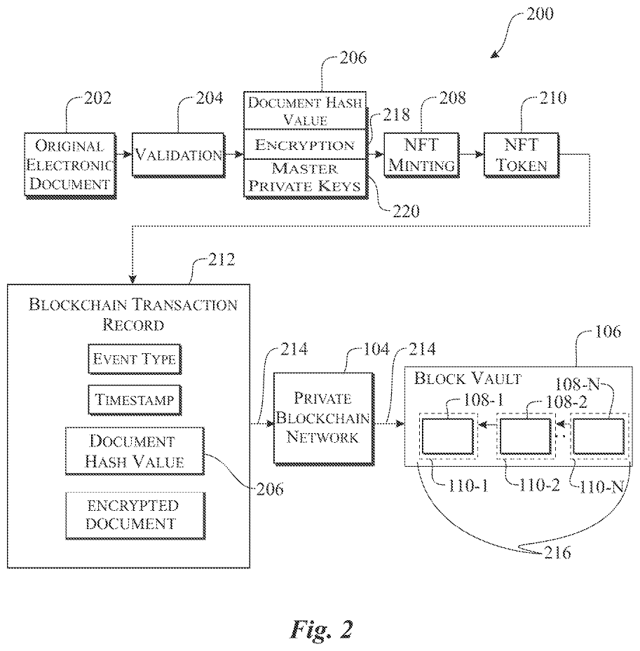

Turning our attention to FIG. 2, a high-level diagram 200 schematically depicting storing an electronic original document using the blockchain-based electronic document vault in accordance with an embodiment. For clarity, the detailed discussion throughout will focus on a blockchain-based implementation however any DLT-based implementation may be effectively utilized in accordance with principles of the disclosed embodiments herein. An electronic document is used as an example of a target digital asset to be stored using the blockchain-based electronic vault, although the techniques can be used to store other type of digital assets, which is also included in the scope of the disclosure. For example, the original electronic document 202 is received (e.g., a legal document such as a last will and testament) for which there is a desired need for security and ensuing the document is not subject to unauthorized modifications, for example. The original electronic document 202 undergoes validation 204 upon receipt. In an embodiment, the original electronic document 202 is configured using a portable document format (PDF) and the validation is performed in accordance with at least one International Organization for Standardization (ISO) promulgated standard. As will be appreciated, there exist any number of PDF validation tools that may be utilized (e.g., CommonLook PDF Validator, PDF Checker and 3-Heights PDF Validator Online Tool, to name just a few). In some implementations, the validation determines whether the electronic document is compliant with the specifications requirement of that particular type of electronic document. Upon validation, a document hash value 206 is generated of the validated electronic document, a private key 220 is also generated for the validated electronic document and the original electronic document is encrypted 218 using the private key 220 generated. In an embodiment, the private key generated is stored in a central key repository (e.g., the private key store 114 or the private key server 120) or using one or more of the digital wallets 130 by a third-party (e.g., a third-party administrator of the Block Vault document management system 600 and associated Block Vault 106). In an embodiment, the document hash value 206 is stored in a central database, e.g., in the private key server 120 or in a different database server like database 148. In an embodiment, the third-party is unaffiliated with any user, and author of, party to, or individual identified in the electronic document received. Further, the private key 220, in accordance with the principles of the disclosed embodiments, provides validation and viewing properties but not any document editing properties. In some implementations, this third-party is unaffiliated (i.e., independent) from any party who may have authored a particular electronic document or is identified in the electronic document. For example, the third-party manages all private keys used to access the Block Vault 106 and the plurality of digital document vaults therein where each such digital document vault is used for storing a particular one electronic document. Illustratively, each private key is held in the private key store 114 or a particular one digital wallet controlled by the third-party (e.g., the digital wallets 130) whereby the private key is used to provide access to a particular digital document vault 108, as further detailed herein below. For example, in accordance with some implementations of the disclosed embodiments, these private keys are under the sole control of the third-party responsible for managing access to the Block Vault 106. That is, a particular one digital document vault provides for storing the validated electronic document encrypted on the private blockchain (using the associated NFT) whereby a controlled access to and use of the particular one digital document vault is managed as a function of at least the private key generated. Thus, access to and use of the electronic document is by and through the associated digital document vault. Illustratively, such controlled access to and use of the digital document vault is administered by the unaffiliated third-party that issues and controls the private keys (each one private key associated with a particular one digital document vault) which are utilized by the system (or in accordance with the method) for executing controlled access to and use of the particular one digital document vault as a function of the private key generated. As such, any one authorized user is never provided the private key itself for any purpose but rather once authenticated they are provided access to the desired electronic document by and through the associated digital document vault on the private blockchain as a function of the private key managed and controlled by the unaffiliated third-party. As such, the third-party serves as a central validator/verifier of the authenticity of the electronic documents held by the Block Vault 106. In some implementations, one or more master keys can be generated to be held solely by the unaffiliated third party, which could be used to access and/or decrypt multiple encrypted electronic document (digital asset). For example, each master key can be configured to access and decrypt one kind of encrypted electronic documents. In some implementations, some master key can be used to access and/or decrypted any encrypted digital assets.

Then, there is a minting 208 a non-fungible token (NFT) for tokenizing the validated electronic document encrypted and the document hash generated into an NFT token 210. In an embodiment, the author or the party responsible for the electronic document (e.g., a lawyer) may choose to include identifying information for each NFT token 210 (and associated private key) including, but not limited, to names, current addresses, birth dates, social security numbers and other personal identifying information. This identifying information would be minted with the NFT token but stored separately (e.g., the application data 112). Also in some implementations, at the time of submission of the original electronic document 202 there may be certification that, to the best of the person's knowledge, the submitted electronic document is a true and correct copy of the original hard-copy document and that the person is authorized to place the original electronic document 202 into the Block Vault 106 and on the blockchain 216.

A request 214 is executed for writing and posting the NFT token 210 to a blockchain (e.g., private blockchain 216 as provided by the private blockchain network 104). Such request is formulated by using at least blockchain transaction record 212 comprising, e.g., an event type, timestamp, and the document hash value 206. In this way, in accordance with the principles of the disclosed embodiments, there is a forming, by recording the NFT token 210 minted as a particular one block (e.g., the block 110-1) of a plurality of blocks (e.g., block 110-1 through block 110-N) on a private blockchain (e.g., the private blockchain 216), a particular one digital document vault (e.g., the digital document vault 108-1) of a plurality of digital document vaults (e.g., digital document vault 108-1 through digital document vault 108-N) of an electronic storage vault (e.g., the Block Vault 106) residing on the private blockchain 216. Thus, the particular one digital document vault provides for storing the validated electronic document encrypted on the private blockchain and controlling access thereto as a function of at least the private key generated. In some implementations, the encrypted electronic document is also minted as part of the block of the NFT token 210 or as a separate block that is linked to the block of the NFT token 210. In some implementations, the encrypted electronic document is stored in a digital document vault 108-1 through 108-N in the blockchain. As such, the encrypted electronic document is stored directly onto the blockchain. In some implementations, the encrypted electronic document is stored off-chain, such as in a third-party repository, and a link to the off-chain location of the encrypted electronic document is stored on the blockchain, e.g., in a same block as the NFT token 210.

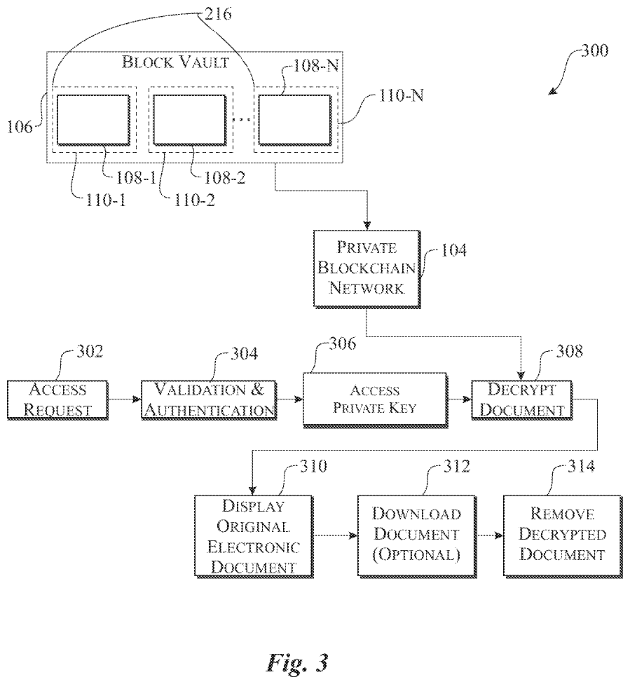

Turning our attention to FIG. 3, a high-level diagram 300 is shown schematically depicting electronic document access and management using a blockchain-based electronic document vault in accordance with an embodiment. More particularly, receiving an access request 302. The access request may be made by any individual or entity (e.g., testator, beneficiaries, lawyers, account, insurance company, and healthcare provider, to name just a few) seeking access to a particular electronic document (e.g., the original electronic document 202) stored using the Block Vault 106. As noted above, a third party is responsible for managing access to the Block Vault 106 and the individual digital document vaults thereof (e.g., the digital document vault 108-1 through 108-N). Thus, in an embodiment, validation and authentication 304 of the user making the access request 302 is performed by such third-party. This will ensure that the user making such access request 302 is properly authorized for accessing the original electronic document 202. If so, the private key is accessed 306 and utilized by the unaffiliated third-party (e.g., by and through the Block Vault document management system 600) in order to provide controlled access and use of the digital document vault holding the desired electronic document for purposes of providing the user with the requested access and use of such electronic document. That is, the third party will utilize the particular private key held by them in the private key store 114, for example, and unlock access to and use of the associated digital document vault in response to the access request 302. In this way, the user requesting access is never provided access to or possession of the private key itself. This will enable the user to access the original electronic document 202 which is executed by retrieving a copy of the encrypted electronic document from one of the digital document vaults (e.g., the digital document vault 108-1 of block 110-1 of the blockchain 216) of the Block Vault 106. The copy of the encrypted document is stored, illustratively, in a secure file space, e.g., a secure cache and then decrypted 308 and displayed 310 to the user thereby allowing the user to review the original electronic document 202. The user may, in some implementations, download 312 the electronic document for their local use (e.g., on their personal computer). Of course, this download of the electronic document no longer will retain the protection of the Block Vault 106, but the original electronic document does in that such document remains protected (and unaltered) by its respective digital document vault. Once the displaying and/or downloading is completed, the decrypted electronic document is removed 314. That is, in an embodiment, there is copying of the validated electronic document encrypted into a secure cache (e.g., by the Block Vault document management system 600 and/or the encryption/decryption server 126) as part of the access from its digital vault and the decrypting is executed from (and stored temporality in) the secure cache. As such, the decrypted electronic document is deleted from the secure cache at such time that the displaying and/or downloading is completed.

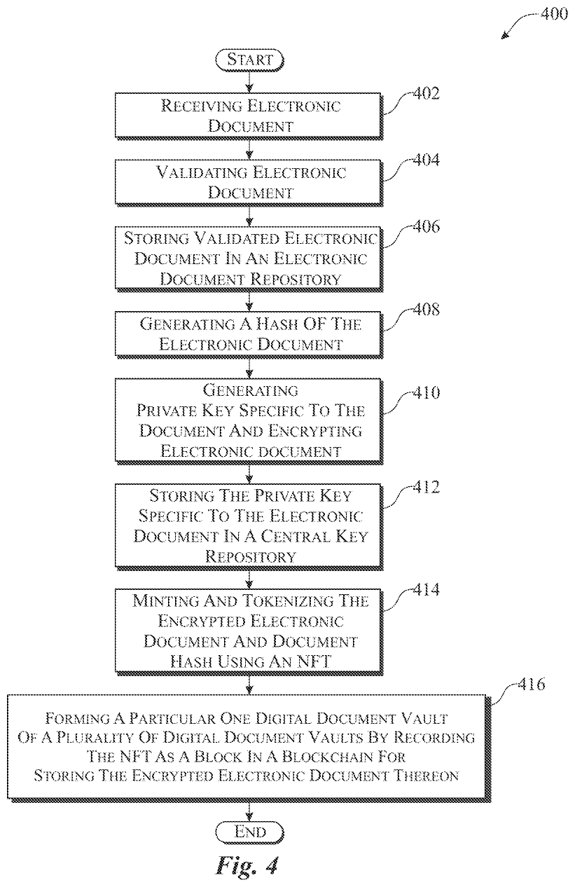

Turning our attention to FIG. 4 and in furtherance of the discussion with reference to FIG. 2 herein above, a flowchart of illustrative operations 400 is shown for implementing a blockchain-based electronic document vault for storing an electronic document in accordance with an embodiment. More particularly, at step 402, receiving an electronic document and, at step 404, validating the electronic document. In some implementations, at step 406, storing the validated electronic document in an electronic document repository. For example, storing the document in the document store 118 in accordance with any document retention requirements or other legal requirements that may apply. In this way, there is always an original copy of the document retained by the system. In an embodiment, there may be the applying of a digital signature of an individual to the electronic document received, wherein the individual is an author of, a party to, or identified in the electronic document received. In addition, there may also be the applying of a digital signature of the unaffiliated third-party to the electronic document received (either in addition to the aforementioned digital signature or on a stand-alone basis). Generating, at step 408, a document hash of the validated electronic document. Then, at step 410 generating a private key specific to the electronic document and encrypting the electronic document. As noted previously, the unaffiliated third-party issues and controls the private keys at all times. The private keys are utilized for executing controlled access to and use of the particular one digital document vault as a function of the private key generated. In some implementations, one or more of the encrypted electronic document or the hash of the electronic document may also be stored in an electronic document repository, e.g., a central database or a file server. As such, any one authorized user is never provided the private key itself for any purpose but rather once authenticated they are provided access to the desired electronic document by and through the associated digital document vault on the private blockchain as a function of third-party managed and controlled private key. At step 412, storing the private key generated in a central key repository. Then, at step 414, minting an NFT for tokenizing one or more of the validated electronic document encrypted or the document hash generated. At step 416, forming, by recording the NFT minted as a particular one block of a plurality of blocks on a private blockchain, a particular one digital document vault of a plurality of digital document vaults of an electronic storage vault residing on the private blockchain, wherein the particular one digital document vault provides for storing the validated electronic document encrypted on the private blockchain and controlling access thereto as a function of at least the private key generated. In some implementations, a location of the particular one block, e.g., as the digital document vault, is stored in a central database for ease of searching, locating and future use of the encrypted electronic document.

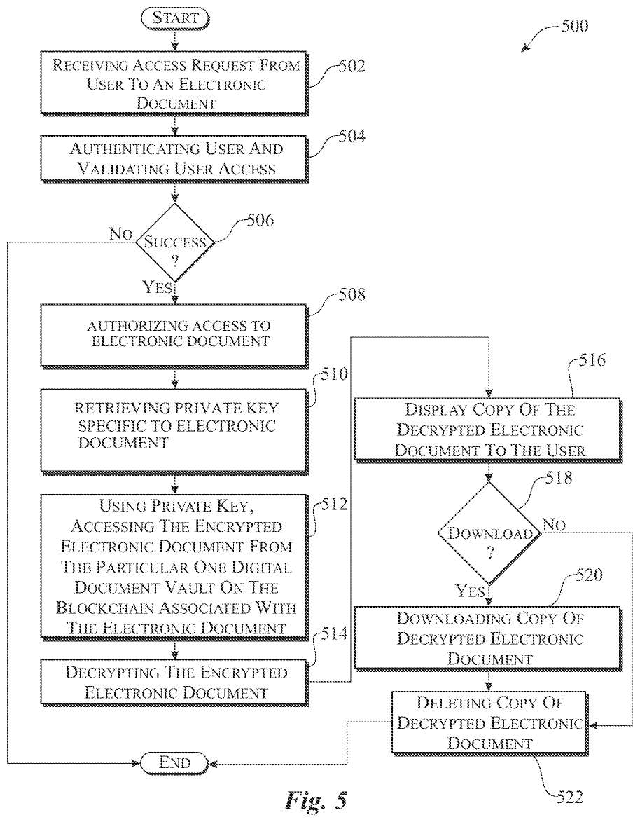

Turning our attention to FIG. 5 and in furtherance of the discussion with reference to FIG. 3 above, a flowchart of illustrative operations 500 for electronic document access and management using a blockchain-based electronic document vault in accordance with an embodiment. More particular, at step 502, receiving an access request from a user to an electronic document and at step 504, authenticating the user and validating user access. Illustratively, the authentication is performed by the Block Vault document management system 600 which may comprise an authentication server and a central database for such purposes. If authentication and validation fails, then the operations end. If step 506 is successful, authorizing access to the electronic document at step 508, and retrieving the private key at step 510 (e.g., retrieving by the Block Vault document management system 600 from the private key store 114) specific to the associated digital document vault (and, therefore the electronic document for which access is requested and authorized including in the document's encrypted and/or decrypted states as employed herein). That is, responsive to the authentication of the user and the validation of their access to the electronic document received, retrieving the private key stored from the central key repository. In an embodiment, the user may be presented with a listing of electronic documents for which they are authorized, and the user may select one or more of the listed items. Illustratively, the listing may be compiled by the Block Vault document management system 600 from content in the document store 118. In an embodiment, the retrieval of the private key is triggered by a request from the encryption/decryption server 126. At step 512, using the private key retrieved, accessing the encrypted electronic document from the particular one digital document vault on the blockchain associated with the electronic document (e.g., the digital document vault 108-1 of the Block Vault 106). Illustratively, there is the accessing using the private key retrieved the particular one digital document vault of the plurality of digital document vaults of the electronic storage vault residing on the private blockchain and the minted NFT recorded for providing the user with access to and use of the validated electronic document encrypted thereof. Again, the private key is solely under the management and control of the unaffiliated third-party responsible for the administration of the Block Vault document management system 600 and the blockchain-based electronic storage vault 106, for example. Then, at steps 514 and 516, decrypting the encrypted electronic document and displaying the electronic to the user. In some implementations, at step 518, the user may choose to download the displayed electronic document. If no such downloading is desired, after display of the document is completed, at step 522, one or more of the encrypted electronic document and or the decrypted electronic document copy is deleted (e.g., from a secure cache). Otherwise, at step 520, downloading a copy of the decrypted electronic document and at step 522, deleting the copy (e.g., from a secure cache) of one or more of the decrypted electronic document or the encrypted electronic document.

Turning our attention to FIG. 6, a Block Vault document management system 600 is configured in accordance with an embodiment. As shown, the Block Vault document management system 600 comprises processor 602 for executing program code (e.g., the Block Vault document management app 800 configured in accordance with FIG. 8) and communications interface 614 for managing communications to and from the Block Vault document management system 600, memory 606 and read-only memory (ROM) 608 for storing program code and data, and power source 618 for powering the Block Vault document management system 600. The memory 606 is coupled to the bus 604 for storing computer-readable instructions (e.g., non-transitory computer readable medium) to be executed by the processor 602 including, but not limited to, the Block Vault document management app 800. Database manager 612 is used to manage the delivery and storage of content, data, and other information in any well-known database(s) types (including but not limited to, the application data 112, the private key store 114, the private blockchain data 116, and the document store 118) necessary and/or useful in delivering the blockchain-based electronic storage vault 106. As detailed herein, the operations performed by for the Block Vault document management system 600 in combination with the Block Vault document management app 800, for example, provide for the delivery of a blockchain-based electronic document vault for electronic document storage, access and management in accordance with the disclosed embodiments.

Web and mobile APT manager 620 is used to deliver and manage content, data, and other information across one or more web-based applications (e.g., as enabled by using web APT 134) and mobile-based applications (e.g., as enabled by using the mobile APT 132), as the case may, that may be utilized to access and use the Block Vault document management system 600, for example. Further, the operations provided by and through the Block Vault document management app 800 may be offered, in whole or in part, through a web-based application in addition to the mobile-based application. As will be discussed in greater detail herein below, the Block Vault document management app 800, as stored in data storage 610, when executed by the processor 602 will enable access by a plurality of users (e.g., the user 1 150-1 through user N 150-N and/or the user A 152-1 trough user Z 152-N) to the Block Vault document management system 600 for the blockchain-based electronic document vault (e.g., the Block Vault 106) for electronic document storage, access and management in accordance with the disclosed embodiments. Such processing is further enabled by private blockchain manager 624, private key generator and manager 628, public blockchain manager 632, digital wallet manager 626, smart contract manager 634, digital document vault manager 630, and encryption, decryption manager 636, and hash generator manager 638.

Location-based services manager 622 facilitates the delivery of location-based services (e.g., GPS tracking) either independently or on a user device (e.g., the user device 700) thereby allowing the Block Vault document management system 600 to register the exact location of the user of the user device, for example, as the user roams from one location to another location such that the blockchain-based electronic document vault platform and services offered hereunder. In an embodiment, the operations provided through the execution of the Block Vault document management app 800 may also include a web-based delivery platform and/or accessing and interfacing any number of websites using the web and mobile APT manager 620 for procuring information and data that can be used in the Block Vault document management system 600. The term “website” in the context herein is used in a conventional and broadest sense and is located on at least one server containing web pages stored thereon and is operational in a 24-hour/7-day typical fashion. The Block Vault document management system 600 may also include one or more input/output devices 616 that enable user interaction with the various user devices (e.g., camera, display, keyboard, mouse, speakers, microphone, buttons, etc.). The input/output devices may include peripherals, such as an NFC device (e.g., NFC tag reader), camera, printer, scanner (e.g., QR-code scanner), touchscreen display, etc. For example, the input/output devices 616 may include a display device such as a cathode ray tube (CRT), plasma monitor, liquid crystal display (LCD) monitor or organic light-emitting diode (OLED) monitor for displaying information to the user, a keyboard, and a pointing device such as a mouse or a trackball by which the user can provide input to the user device or an associated display device, for example.

The communications interface 614 is used to facilitate communications across the communications links 154 (see, FIG. 1) within the cloud network services architecture 100. This may take the form, for example, of a wide area network connection that communicatively couples the Block Vault document management system 600 with one or more access points which may include a cellular communications service. Similarly, communications managed by the communications interface 614 may take the form, for example, of a local Wi-Fi network interface or Ethernet interface the communicatively couples the Block Vault document management system 600 with the well-known Internet, and ultimately to any user device. In the instant embodiment, the Block Vault document management app 800 and/or the communications interface 614 may include a communications stack for facilitating communications over the respective communications link 154. Electronic communications by and through Block Vault document management system 600 between the various systems, networks, devices, users, entities, and/or individuals are facilitated by the communications links 154 in accordance with any number of well-known communications protocols and methods (e.g., wireless communications).

Turning our attention to FIG. 7, an illustrative user device 700 is shown for use with the Block Vault document management system 600, for example, in accordance with an embodiment. The user device 700 typically includes bus 702 and processor 704 coupled to the bus 702 for executing operations and processing information. As will be appreciated, a “user device” in the context herein may comprise a wide variety of devices such as any type of hardware device, user devices, smartphones, laptop computers, desktop computers, tablets, and wearable devices, to name just a few, that execute applications (e.g., a mobile application) in accordance with the principles of the disclosed embodiments herein. For example, the execution of the Block Vault document management app 800 as detailed herein. The processor 704, as powered by power source 712, may include both general and special purpose microprocessors, and may be the sole processor or one of multiple processors of the device. This is equally applicable to the processor 602 of FIG. 6. Further, the processor 704 (or the processor 602) may comprise one or more central processing units (CPUs) and may include, be supplemented by, or incorporated in, one or more application-specific integrated circuits (ASICs) and/or one or more field programmable gate arrays (FPGAs).

The user device 700 may also include memory 706 coupled to the bus 702 for storing computer-readable instructions to be executed by the processor 704. The memory 706 may also be utilized for storing temporary variables or other intermediate information during the execution of the instructions by the processor 704. The user device 700 may also include ROM 708 or other static storage device coupled to the bus 702. Further, data storage device 710, such as a magnetic, optical, or solid-state device may be coupled to the bus 702 for storing information and instructions for the processor 704 including, but not limited to, the Block Vault document management app 800. Data storage device 710 (or the data storage device 610) and the memory 706 (and the memory 606) may each comprise a non-transitory computer readable storage medium and may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

The user device 700 may also include one or more communications interface 716 for communicating with other devices via a network (e.g., a wireless communications network) or communications protocol (e.g., Bluetooth®). For example, such communication interfaces may be a receiver, transceiver, or modem for exchanging wired or wireless communications in any number of well-known fashions. For example, the communications interface 716 (or the communications interface 614) may be an integrated services digital network (ISDN) card or modem/router used to facilitate data communications of various well-known types and formats. Further, illustratively, the communications interface 716 (or the communications interface 614) may be a local area network (LAN) card used to provide data communication connectivity to a comparable LAN. Wireless communication links may also be implemented. The Global Positioning System (GPS) transceiver 718 and antenna 720 facilitate delivery of location-based services in order to register the exact location of the user device 700, for example, as the user roams from one location to another location. As will be understood, the application herein will be able to track individual users upon the launching of the application thereby enabling the well understood GPS location features of the user device 700 (e.g., a smartphone or desktop location services).

As will be appreciated, the functionality of the communication interface 716 (or the communications interface 614) is to send and receive a variety of signals (e.g., electrical, optical, or other signals) that transmit data streams representing various data types. The user device 700 may also include one or more input/output devices 714 that enable user interaction with the user device 700 such as a camera, display, keyboard, mouse, speakers, microphone, buttons, etc. The input/output devices 714 (or T/O devices 616) may include peripherals, such as an NFC device (e.g., NFC reader), camera, printer, scanner (e.g., QR-code scanner), touchscreen display, etc. For example, the input/output devices 714 (or the T/O devices 616) may include a display device such as a cathode ray tube (CRT), plasma monitor, liquid crystal display (LCD) monitor or organic light-emitting diode (OLED) monitor for displaying information to the user, a keyboard, and a pointing device such as a mouse or a trackball by which the user can provide input to the user device 700 or an associated display device, for example.

Turning our attention to FIG. 8, an illustrative architecture for a Block Vault document management app 800 for delivering and executing the aforementioned blockchain-based electronic storage vault 106 and associated operations, platform and services in accordance with an embodiment. As will be appreciated, the architecture may be used, illustratively, in conjunction with the cloud network services architecture 100, the Block Vault document management system 600, and/or the user device 700 for launching and executing the Block Vault document management app 800. As shown, the architecture for the operations of the Block Vault document management app 800 provides several interfaces and engines used to perform a variety of functions such as the collection, aggregation, manipulation, processing, analyzing, verification, authentication, and display of applicable real-time information and data that are useful to realize the delivery of the blockchain-based electronic storage vault for storing, accessing and managing electronic document in a secure fashion, as detailed herein. More particularly, data display interface module 818 and communications module 812 are used to facilitate the input/output and display of electronic data and other information to, illustratively, the users (e.g., the user 1 150-1) employing the user device 700 (e.g., a touch screen) for engaging with the Block Vault document management app 800 and the execution thereof. The data collection module 806 facilitates data gathering from a plurality of users and other third parties. The location-based services module 820 provides for the delivery of location-based services in order for the geographic locations of the users to be identified and displayed (e.g., GPS locations) in accordance with any location and proximity-based features of the Block Vault document management app 800. The communications module 812 will also facilitate communications by and through the Block Vault document management system 600, for example.

Execution engine 802 may be employed to deliver the operations pursuant to the execution of the Block Vault document management app 800. In such delivery, the execution engine 802 will operate and execute, as further detailed herein below, with at least the following program modules: private blockchain administration and management module 804, data collection module 806, public blockchain administration and management module 808, digital document vault administration and management module 810, communications module 812, Block Vault document management system operations module 814, smart contract administration and management module 816, data display interface module 818, location-based services module 820, digital wallet administration and management module 822, currency administration and management module 824, document hash administration and administration module 826, encryption and decryption administration and management module 828, and web and mobile APT administration and management module 830, and private key administration and management module 832. In an embodiment, the data display interface module 818, and the communications module 812 are used to facilitate the input/output and display of electronic data and other information (e.g., a graphical user interface) to, illustratively, the users employing the user device 700 (e.g., a touch screen of the user device 700) and executing the Block Vault document management app 800 including, but not limited to, the operations executed by each and every of the foregoing modules are, for example, as discussed herein above with reference to FIGS. 2-5.

Those skilled in the art will appreciate that the present disclosure contemplates the use of systems configurations and/or computer instructions that may perform any or all of the operations detailed herein above. For example, the disclosure of computer instructions that include, for example, the Block Vault document management system 600 and the Block Vault document management app 800 is not meant to be limiting in any way. Those skilled in the art will readily appreciate that stored computer instructions and/or systems configurations may be configured in any way while still accomplishing the various goals, features, and advantages according to the present disclosure. The terms “program,” “application,” “software application,” and the like as used herein, are defined as a sequence of instructions designed for execution on a computer system. A “program,” “computer program,” “application,” or “software application” may include a subroutine, a function, a procedure, an object method, an object implementation, an executable application, an applet, a servlet, a source code, an object code, a shared library/dynamic load library, and/or other sequence of instructions designed for execution on a computer system. Accordingly, the applications and programs, for example, may be written using any number of programming languages and/or executed on compatible platforms including, but not limited to, JavaScript, PHP (PHP: Hypertext Preprocessor), WordPress, Drupal, Laravel, React.js, Angular.js, and Vue.js. Computer readable program instructions for carrying out operations of the disclosed embodiments may be assembler instructions, instruction-set-architecture (TSA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions (e.g., non-transitory computer readable mediums) may execute entirely on one or more standalone computers, partly on one or more standalone computers, as a stand-alone software package, partly on one or more standalone computers and partly on one or more remote computers, partly on one or more standalone computers and partly on one or more distributed computing environments (such as a cloud environment), partly on one or more remote computers and partly on one or more distributed computing environments, entirely on one or more remote computers or servers, or entirely on one or more distributed computing environments. Standalone computers, remote computers, and distributed computing environments may be connected to each other through any type of network or combination of networks, including local area networks (LANs), wide area networks (WANs), through the Internet (e.g., using an Internet Service Provider), or the connection may be made to external computers.

As noted above, in some embodiments the method or methods described above may be executed or carried out by a computing system including a non-transitory computer-readable storage medium, also described herein as a storage machine, that holds machine-readable instructions executable by a logic machine (i.e., a processor or programmable control device) to provide, implement, perform, and/or enact the above-described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUT), or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard, or gaming controller. For example, a user input may indicate a request that certain task is to be executed by the computing system, such as requesting the computing system to display any of the above-described information or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (APT).

Thus, the steps of the disclosed method (see, e.g., FIGS. 2-5) and the associated discussion herein above can be defined by the computer program instructions stored in a memory and/or data storage device and controlled by a processor executing the computer program instructions. Accordingly, by executing the computer program instructions, the processor executes an algorithm defined by the disclosed method. For example, the computer program instructions can be implemented as computer executable code programmed by one skilled in the art to perform the illustrative operations defined by the disclosed methods. Further, it will be appreciated that any flowcharts, flow diagrams, state transition diagrams, pseudo code, program code and the like represent various processes which may be substantially represented in computer readable medium and so executed by a computer, machine, or processor, whether or not such computer, machine or processor is explicitly shown. One skilled in the art will recognize that an implementation of an actual computer or computer system may have other structures and may contain other components as well, and that a high-level representation of some of the components of such a computer is for illustrative purposes.

Since many modifications, variations, and changes in detail can be made to the described example embodiments of the disclosure, it is intended that all matters in the foregoing description and shown in the accompanying drawings be interpreted as illustrative and not in a limiting sense. Thus, the scope of the disclosure should be determined by the appended claims and their legal equivalents.

1. A method comprising:
receiving a digital asset;
generating a first hash of the digital asset;
generating a private key for the digital asset;
storing the private key in a central key repository;
encrypting the digital asset using the private key to generate an encrypted digital asset;
minting a non-fungible token (NFT) by tokenizing the encrypted digital asset and the first hash; and
forming, by recording the NFT in a block of a plurality of blocks on a blockchain, the block configured as a digital asset vault of a plurality of digital asset vaults of an electronic storage vault residing on the blockchain, the digital asset vault being configured to be accessed using the private key.

2. The method of claim 1, comprising storing a location of the digital asset vault in a central database.

3. The method of claim 1, comprising assessing the encrypted digital asset from the digital asset vault using the private key.

4. The method of claim 3, comprising:
copying the encrypted digital asset from the digital asset vault to a secure file space;
decrypting the encrypted digital asset using the private key to generate a decrypted digital asset in the secure file space; and
displaying the decrypted digital asset to an authenticated user.

5. The method of claim 4, comprising:
generating a second hash of the decrypted digital asset; and
comparing the second hash with the first hash.

6. The method of claim 4, comprising deleting one or more of the encrypted digital asset or the decrypted digital asset from the secure file space.

7. The method of claim 1, wherein the central key repository is separate from a blockchain network where the blockchain resides.

8. The method of claim 1, comprising validating the digital asset received before generating the first hash.

9. The method of claim 1, comprising storing one or more of the first hash or the encrypted digital asset in an off-chain file storage space.

10. A computer system comprising one or more storage devices and one or more processors communicatively coupled to the one or more storage devices, the one or more storage devices, individually or collectively, having computer executable instructions stored thereon, which when executed by the one or more processors, enable the one or more processors to, individually or collectively, implement acts including:
receiving an digital asset;
generating a first hash of the digital asset;
generating a private key for the digital asset;
storing the private key in a central key repository;
encrypting the digital asset using the private key to generate an encrypted digital asset;
minting a non-fungible token (NFT) by tokenizing the encrypted digital asset and the first hash; and
forming, by recording the NFT in a block of a plurality of blocks on a blockchain, the block configured as a digital asset vault of a plurality of digital asset vaults of an electronic storage vault residing on the blockchain, the digital asset vault being configured to be accessed using the private key.

11. The computer system of claim 10, wherein the acts include storing a location of the digital asset vault in a central database.

12. The computer system of claim 10, wherein the acts include:
assessing the encrypted digital asset from the digital asset vault using the private key;
copying the encrypted digital asset from the digital asset vault to a secure file space;
decrypting the encrypted digital asset using the private key to generate a decrypted digital asset in the secure file space; and
displaying the decrypted digital asset to a user.

13. The computer system of claim 12, wherein the acts include:
generating a second hash of the decrypted digital asset; and
comparing the second hash with the first hash.

14. The computer system of claim 12, wherein the acts include deleting one or more of the encrypted digital asset or the decrypted digital asset from the secure file space.

15. The computer system of claim 10, wherein the central key repository is separate from a blockchain network where the blockchain resides.

16. The computer system of claim 10, wherein the acts include validating the digital asset received before the generating the first hash.

17. The computer system of claim 10, wherein the acts include one or more of storing one the first hash in an off-chain database or storing the encrypted digital asset in an off-chain file storage space different from the off-chain database.

18. A non-transitory storage medium having computer executable instructions stored thereon, the computer executable instructions when executed by the one or more processors, enabling the one or more processors to, individually or collectively, implement acts including:
receiving an digital asset;
generating a first hash of the digital asset;
generating a private key for the digital asset;
storing the private key in a central key repository;
encrypting the digital asset using the private key to generate an encrypted digital asset;
minting a non-fungible token (NFT) by tokenizing the encrypted digital asset and the first hash; and
forming, by recording the NFT in a block of a plurality of blocks on a blockchain, the block configured as a digital asset vault of a plurality of digital asset vaults of an electronic storage vault residing on the blockchain, the digital asset vault being configured to be accessed using the private key.

19. The non-transitory storage medium of claim 18, wherein the acts include:
assessing the encrypted digital asset from the digital asset vault using the private key;
copying the encrypted digital asset from the digital asset vault to a secure file space;
decrypting the encrypted digital asset using the private key to generate a decrypted digital asset in the secure file space; and
displaying the decrypted digital asset to a user.

20. The non-transitory storage medium of claim 19, wherein the acts include:
generating a second hash of the decrypted digital asset; and
comparing the second hash with the first hash.
